(19) United States
(12) Patent Application Publication
(10) Pub. No.: US 2015/0242374 A1
(43) Pub. Date: Aug. 27, 2015

(54) AUTOMATIC LAYOUT TECHNOLOGY

(71) Applicant: Styla GmbH, Berlin (DE)

(72) Inventors: Alexander KONG, Berlin (DE); Markus WESSOLEK, Berlin (DE); Sebastian SACHTLEBEN, Berlin (DE); Philipp ROGGE, Berlin (DE); Iven ZIMMER, Berlin (DE); Franz RIEDL, Berlin (DE); Marcel PUPPIK, Berlin (DE)

(73) Assignee: Styla GmbH, Berlin (DE)

(21) Appl. No.: 14/634,294

(22) Filed: Feb. 27, 2015

Related U.S. Application Data
(60) Provisional application No. 61/945,645, filed on Feb. 27, 2014.

(51) Int. Cl. G06F 17/21; G06F 17/24

(52) U.S. Cl. CPC G06F 17/212; G06F 17/248

(57) ABSTRACT

Described are devices, methods, and non-transitory computer readable media for automatically configuring a layout of content for online publishing or display on an electronic device in a visually pleasing and professional manner The described techniques allow the content to be organized and displayed in a magazine-style layout and design, without a need for high level programming skills or special tools. A layout engine receives content selected by a user for display, configures a first level layout of the content based on a first set of attributes of the content, which includes determining a number of story containers needed to display the stories in the content, and configures a second level layout of a respective story in the content based on a second set of attributes of the respective story in the content. The first level layout determines the high level configuration of the entire display page (e.g., a page layout), and the second level layout determines the lower level configuration for each story container on the display page (e.g., a story layout).

### CROSS-REFERENCE TO RELATED APPLICATION

This is a non-provisional application claiming priority to U.S. Provisional Application No. 61/945,645, which is hereby incorporated by reference in its entirety.

### FIELD

The following disclosure relates to automatic layout technology. More specifically, the following disclosure relates to automatically configuring a layout of content for display.

### BACKGROUND

It has been found that Americans spend more time with online media than they do with traditional forms of media such as print and television. Globally, digital usage including social media and mobile internet usage now accounts for 57% of daily media time. Consequently, in the field of publishing, online media has become a more popular tool to publish content and attract public attention than the traditional forms of media.

To satisfy the increasing need for online publishing, attempts have been made to provide individuals and businesses with tools to configure desired content to be ready for online publishing.

Existing tools, however, require a high level of knowledge and skill to configure the content for display in a visually pleasing manner

### SUMMARY

The descriptions herein relate to devices, methods, and non-transitory computer-readable media that enable an automatically configuration of a layout of any given content. The content may be provided by a user using such devices, methods and non-transitory computer readable media, or may be automatically downloaded or pulled from a remote server, web, etc. In this way, a user can simply select the content for display and the content is automatically displayed in a magazine-quality layout without requiring any skills or knowledge from the user, or specialized tools. Further, the automatic layout configuration may be serviced through a web or the Internet, which allows the laymen users to upload a wider variety of content (e.g., texts, images, movies) in a magazine-style layout on their blogs, posts, online malls, etc.

The automatic layout configuration is done by taking into consideration various conditions of the selected content—for example, non-exclusively, a size, a number of discrete contents for simultaneous display, an image quality (e.g., resolution, pixels), a need for a text box, an orientation, a need for a movie player, etc.

In some embodiments, an electronic device with a display is provided. The automatic layout configuration technology may be performed at this device by receiving content selected by a user; configuring a first level layout of the content in accordance with a first set of attributes of the content selected by the user, wherein configuring the first level layout of the content comprises determining a number of story containers to display distinct stories in the content; configuring a second level layout of a respective story container based on a second set of attributes of a respective story of the content that is associated with the respective story container; and causing display of the content in the one or more story containers on the display of the device, in accordance with the first level layout and the second level layout configured by the device.

In some embodiments, configuring the first level layout of the content comprises configuring a spatial arrangement of the story containers on the display; and configuring the second level layout of the content comprises configuring a spatial arrangement of content within each story container on the display.

In some embodiments, the content comprises a plurality of distinct stories; and each distinct story of the content is displayed in a different story container.

In some embodiments, the respective story of the content comprises an image and a text. Optionally, the respective story of the content comprises a video.

In some embodiments, the first set of attributes comprises a popularity of each distinct story in the content. Optionally, the first set of attributes comprises a parameter set by the user.

In some embodiments, the second set of attributes of the respective story of the content comprises a resolution of an image contained in the respective story.

Optionally, the second set of attributes of the respective story of the content comprises a length of a text contained in the respective story.

In some embodiments, an electronic device with a display automatically configures a layout of content selected by a user. The device comprises one or more processors operatively connected to a non-transitory memory, wherein the memory stores instructions, which when executed by the one or more processors, cause the device to: receive content selected by a user; configure a first level layout of the content in accordance with a first set of attributes of the content selected by the user, wherein configuring the first level layout of the content comprises determining a number of story containers to display distinct stories in the content; configure a second level layout of a respective story container based on a second set of attributes of a respective story of the content that is associated with the respective story container; and cause display of the content in the one or more story containers on the display of the device, in accordance with the first level layout and the second level layout configured by the device.

In some embodiments, a non-transitory computer readable medium is provided. The medium comprises instructions, which when executed by one or more processors of an electronic device, cause the device to: receive content selected by a user; configure a first level layout of the content in accordance with a first set of attributes of the content selected by the user, wherein configuring the first level layout of the content comprises determining a number of story containers to display distinct stories in the content; configure a second level layout of a respective story container based on a second set of attributes of a respective story of the content that is associated with the respective story container; and cause display of the content in the one or more story containers on a display of the electronic device, in accordance with the first level layout and the second level layout configured by the device.

### DESCRIPTION OF THE DRAWINGS

FIG. 1 illustrates examples of a page layout and a story layout according to some embodiments of the invention.

FIG. 2 illustrates further examples of a page layout according to some embodiments of the invention.

FIG. 3 illustrates further examples of a page layout according to some embodiments of the invention.

FIGS. 4A-4C illustrate further examples of a story layout according to some embodiments of the invention.

FIG. 5 illustrates examples of a tool used to create a story according to some embodiments of the invention.

FIG. 6 illustrates examples of a process of using the tool to create a story according to some embodiments of the invention.

FIGS. 7A-7C illustrate examples of a story layout with actionable items according to some embodiments of the invention.

FIG. 8 illustrates an example of a cover page generated using the automatic layout configuration for display according to some embodiments of the invention.

FIG. 9 illustrates an example of a page layout integrated with an online shopping site according to some embodiments of the invention.

FIGS. 10A-10B illustrate further examples of a page layout according to some embodiments of the invention.

FIG. 11 illustrates an example of a processing flow of automatic layout configuration according to some embodiments of the invention.

### DETAILED DESCRIPTION

In the following description of the disclosure and examples, reference is made to the accompanying drawings in which it is shown by way of illustration specific examples that can be practiced. It is to be understood that other examples can be practiced and structural changes can be made without departing from the scope of the disclosure.

Described herein are apparatuses, methods, and computer readable media for automatically configuring a layout of content for display on electric devices (e.g., computer displays, cellphone displays, tablet displays, etc.) in various applications, including but not limited to, E-Commerce and social networking services. The content can be published online for such applications.

The automatic layout configuration technique allows the users to simply provide and select the content desired for display, which is then automatically configured into a magazine-style layout for online publishing or display. This allows any laymen users without any special knowledge of computer programming or specialized tools to present their content in a professional and visually pleasing manner

In some examples, the technique for automatically configuring a layout of content can be achieved using a two-level configuration. At the first level, the content is first configured into a high level layout that determines the overall layout of a display page, e.g., a page layout. The page layout may determine how to divide the display page for displaying various content items, among others. At the second level, the content is then configured into a lower level layout that determines the individual layout for each content item, e.g., a story layout. The page layout configuration and the story layout configuration may be performed based on various factors such as one or more attributes of the feed inputted for display.

A feed inputted for display (e.g., content selected by a user) includes one or more distinct stories; for example, the content may be about different food options in a particular location, and the content includes an image (with or without texts) associated with each food option. Each food option is treated as a distinct story. A story may include one or more display elements. A display element may be an image, a text, a title, a video, other graphical objects, etc.

For example, a user may want to post three stories, a first story about a travel location, a second story about food options and a third story about fashion in the travel location. The first story may include one or more images and text descriptions relating to the travel location, the second story may include one or more images of food and/or restaurants and text description of user reviews, and the third story may include one or more images of people wearing fashion items without a text description, for example. A story may include only a single item such as an image or a text.

A page refers to what a display of a user (a viewer) displays simultaneously on a screen. A page may include only one story or more than one stories. A configuration of the layout of the stories that are to be displayed on a page is called a page layout. For example, the page layout may include a story container for containing a story. If the page layout should be configured to contain multiple stories, it will have multiple story containers. As such, a story container can be used as a placeholder for a story in the page layout. For example, if the layout engine determines that three stories should be displayed on a display page, the page layout is configured to include three story containers. Further, a story container may take a variety of sizes, shapes and forms, including, but not limited to, rectangular shape, circular shape, horizontal orientation, vertical orientation, etc. Further, a story container may be designed to occupy different areas of a display page such as the center of the page, top/bottom corners of the page, etc.

As explained above, a story includes one or more elements, which are organized within a story container. Determining the layout of these elements of a story within a story container is called a story layout. For example, one example story layout may be configured to have a title element in certain font and size and on top center of the story container and have other elements in different fonts and sizes and located in other areas of the story container. Another story layout may be configured to have a title element located at the bottom or middle of the story container, etc. There can be numerous other variations in configuring the story container, as will be appreciated by one of ordinary skill in the art.

The page layout and/or the story layout may be configured such that some story containers or at least some parts of the story containers are not displayed. The partial disclosure may work as a teaser for viewers. For example, a story layout may be configured to display only a title and an image and not display a text description of the story in an attempt to immediately grab viewer's attention from the title and the image. The layout engine may automatically determine which parts are going to be displayed and not displayed based at least on a page layout, a story layout, resolutions of a display device, etc.

A page layout and a story layout are configured automatically by an apparatus, e.g. a layout engine. A layout engine may be a server remote from the content creators and the viewers. Or, alternatively, the layout engine may be installed as part of the system of either the content creators or the viewers. A layout engine includes one or more processors that are configured to execute computer instructions, e.g., algorithms, for performing automatic configuration of the page layout and the story layout. The instructions are stored in a non-transitory computer readable storage medium such as a memory.

A layout engine may automatically configure a page layout by selecting a page template among a list of predetermined templates, and/or configuring the page layout based on inputs and processing them according to an algorithm instead of selecting a predetermined template. The layout engine may also use both methods of selecting a general layout template and configuring the details of the layout based on a predetermined algorithm.

Configuration of a page layout defines overall attributes of a display page including, but not limited to, location, orientation and the size of each story container on a page, ratio and gap between story containers, etc. Configuration of a page layout may take into account a variety of factors that include, but are not limited to, technical specifications of a display device used to display the feed, to one or more attributes associated with the stories in the feed. For example, if a page layout is configured automatically based on an algorithm only, a layout engine may take inputs representing, among other, a story containing five elements and two additional stories each containing a single element, to configure the general page layout with three story containers. The layout engine may further configure the layout to locate the story with five elements in the upper center part of the display page and the other two stories in the right and left sides of the bottom part of the display page.

A layout engine may automatically configure a story layout by selecting a story template among a list of predetermined templates, and/or determining the story layout based on inputs and processing them according to an algorithm instead of selecting a predetermined template. The layout engine may also use both methods of selecting a general layout template and configuring the details of the layout based on a predetermined algorithm. For example, if a story layout is configured based on an algorithm only, a layout engine may take inputs representing, among other, a story containing one headline element, a short text element and three image elements, to configure the general story layout that can accommodate at least five elements. The engine may further configure the layout within a story container to place the headline on the top center, the short text in the center of the story container and the three images next to each other below the text.

In this way, a layout engine can allow individuals to automatically create a consistent magazine-style feed for display with a variety of layout options in a simple and easy manner. Configuration of both a page layout and a story layout can be done automatically by a layout engine without needing much skills and knowledge from the users.

In some examples, a page layout is configured such that it has the same number of story containers as the number of stories that the user has selected or that have been attributed to the user by an algorithm for simultaneous display (e.g., a display feed). In other embodiments, a page layout may be configured such that it includes a greater or smaller number of story containers than the number of the stories the user has selected or the stories that have been attributed to the user by an algorithm.

Further, the story containers do not need to have a shape of a rectangle or a box, as shown in the illustrated examples. Instead, the story containers may have a shape of a circle, a ring, a triangle, a trapezoid, a star, a non-geometric shape, etc. Similarly, the element containers within a story container are not limited to the shape of a rectangle but may have any geometric or non-geometric shape.

A page layout may be configured such that story containers of different characteristics (e.g., shape, size, font, etc.) are arranged to use the space of a display screen in a most efficient way. For example, the story containers may be arranged in a

Tetris-like manner such that there is no space, or only a predetermined gap, between any two adjacent story containers. This may be accomplished by using a design grid on a page layout.

In some embodiments, the layout engine is associated with a host website such that the user inputs the desired content to be organized by the engine and posted on the host website associated with the engine. Optionally, the layout engine operates as a back-end server for a customer website such that the user of the customer website is routed to the layout engine for customization and design of the desired content, which when completed, is sent to the customer site for display and/or online posting.

Optionally, appropriate plug-ins are installed on the layout engine and the customer side to allow routing of the raw contents and the designed contents, which may be implemented as Java classes that perform specialized processing of business messages as those messages pass through an integration engine, such as a “B2B” engine for business-to-business (B2B) messaging. Logic plug-ins can insert rules and business logic along the path traveled by business messages as they make their way through the B2B engine. Router and filter logic plug-ins can be provided for each protocol used for business messaging. A service provider or trading partner can develop and install custom logic plug-ins to provide additional value in hub-and--spoke configuration. Logic plug-ins can be defined and stored in an integration repository and executed in the B2B engine. Logic plug-ins also can be transparent to users.

Plug-ins can utilize a plugin framework, which can be composed of a plug-in manager, a set of interfaces for plug-ins to implement, and a set of mechanisms for plug-ins to implement. These mechanisms can include plug-in notification mechanisms, plug-in lifecycle controls, metadata retrieval mechanisms, object manufacturing and downloading mechanisms, XML parsers, plug-in instance monitoring, and type checking. A plug-in manager can manage all plug-ins in the framework, and can be a concrete implementation of the plug-in framework on the server. The plug-in manager can be the central hub through which all plug-in related client requests are routed.

A plug-in can be designed and implemented as an Enterprise JavaBean (EJB). In order for a plug-in manager to manipulate all plug-ins, certain interfaces can be implemented. Each plug-in can have a home interface that can enable a plug-in manager to detect deployed plug-ins, such as by traversing a JNDI tree. A plug-in can also have a remote interface.

In some embodiments, the layout engine receives the content selected by the user, and creates a website displaying the content after automatically configuring the most visually pleasing layout of such content for display. These websites may include the standard HTML pages, websites created using the Cascading Style Sheets (CSS) with absolute positioning properties, or other document display formats, such as, non-exclusively, Portable Document Format (PDF) or Extensible Application Markup Language (XAML).

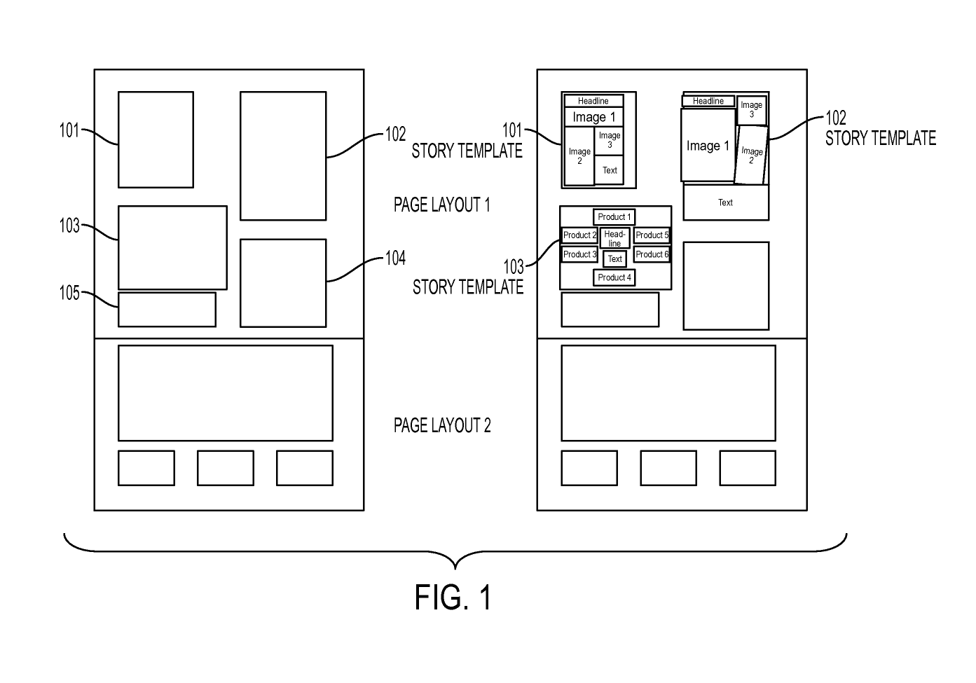

More detailed descriptions of the technique of automatically configuring the layout of the user-selected content are provided below. FIG. 1 illustrates two examples of a page layout and three examples of a story layout. In the illustration, page layout 1 represents an example of a page layout with five different story containers and page layout 2 represents another example of a page layout with four story containers. The five story containers in page layout 1 are referred to as story containers 101, 102, 103, 104 and 105. Three examples of a story layout for story containers 101, 102 and 103 are shown next to the high-level drawing of page layout 1. Story container 101 has five element containers—a headline container, three image containers (image 1, 2, 3), and a text container. Story container 102 also has the same five element containers as story container 101 but the containers are configured differently in terms of size, location and orientation. For example, the image 1 container of the story layout 102 is significantly larger than that of the story layout 101. The image 2 container of the story layout 102 has a vertical orientation that is slightly tilted to the right, whereas the image 2 container of the story layout 101 has a straight vertical orientation. Story container 103 has eight containers—6 product containers (product 1-6), a headline container and a text container. In this story layout, the product containers are surrounding the headline and the text to grab readers' attention with the centered description of the products surrounded by the images of the product.

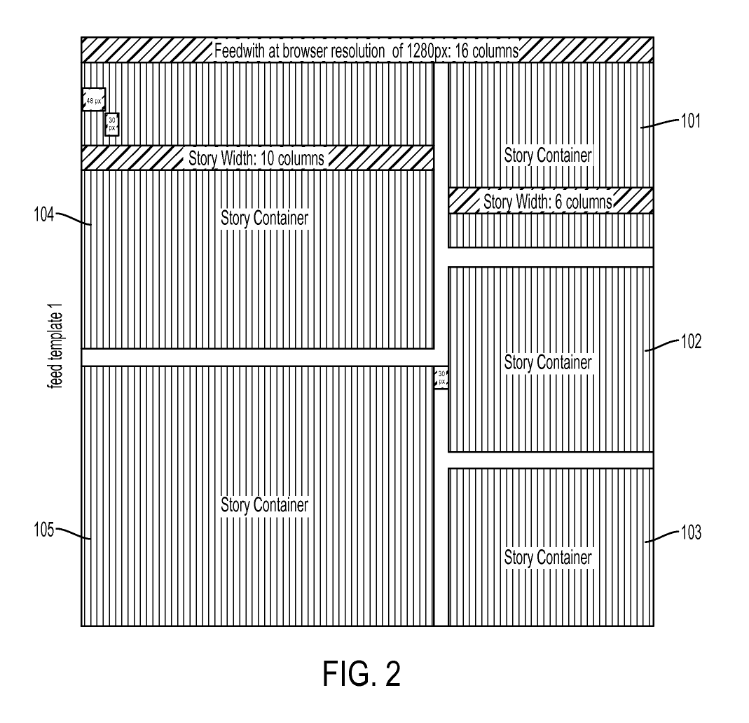

FIG. 2 illustrates another example of a page layout that includes five different story containers 101, 102, 103, 104 and 105. A width of the entire template is 16 columns, assuming that the display browser has the resolution of 1280 pixels. Three story containers have the width of 6 columns and two story containers have the width of 10 columns As will be explained in more detail herebelow, the size of the feed template as well as the sizes of the story containers can be customized for each story based on various input factors, including, but not limited to, the display browser resolution, the number of images contained in the stories, the number of stories, etc.

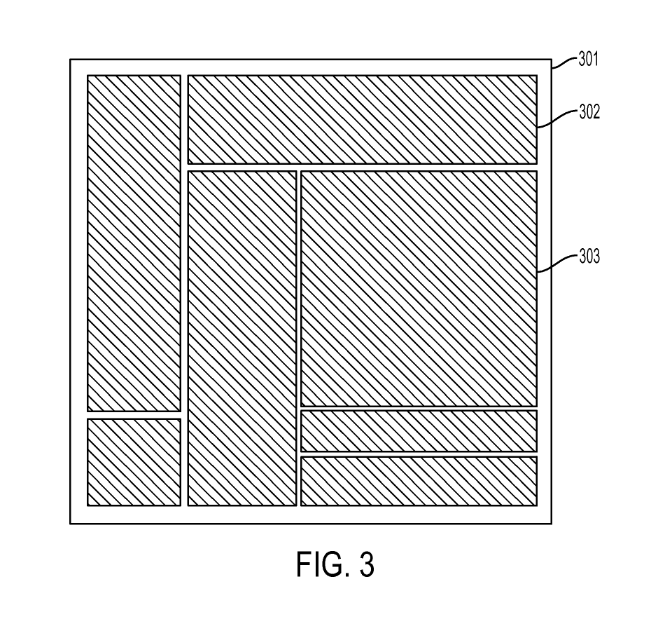

FIG. 3 illustrates another example of a page layout that shows a Tetris-like arrangement of story containers.

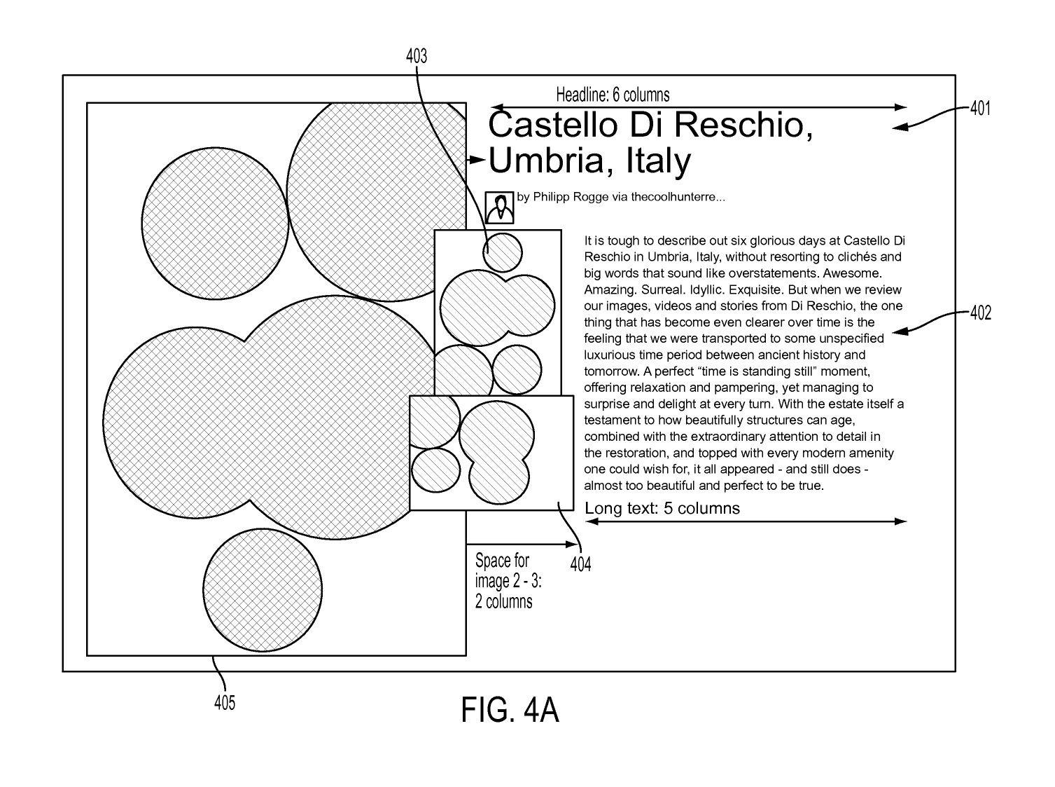

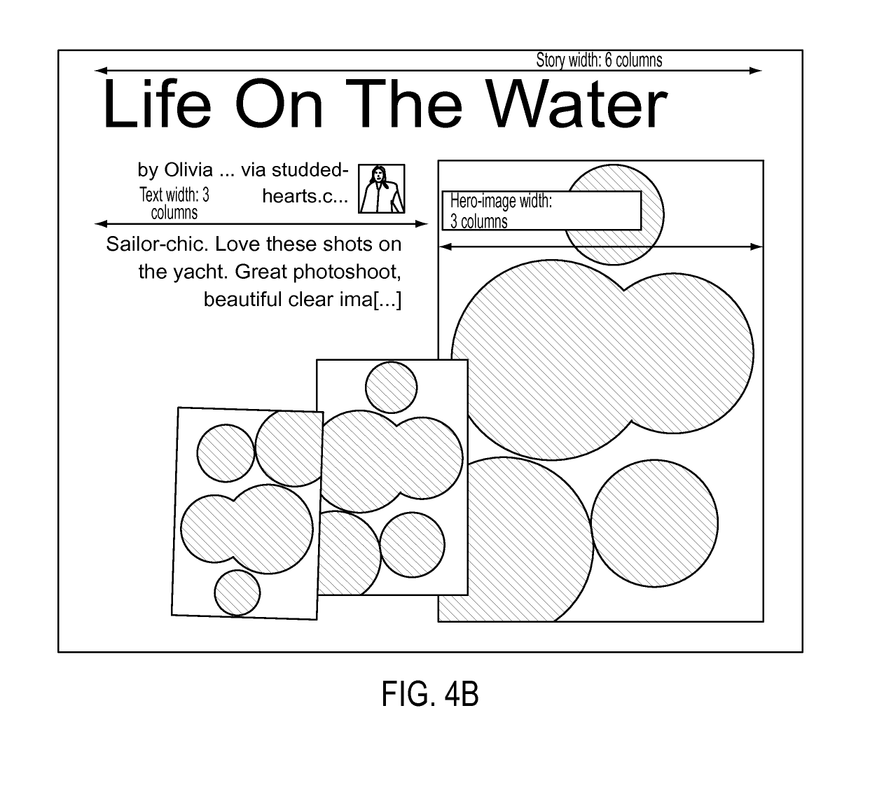

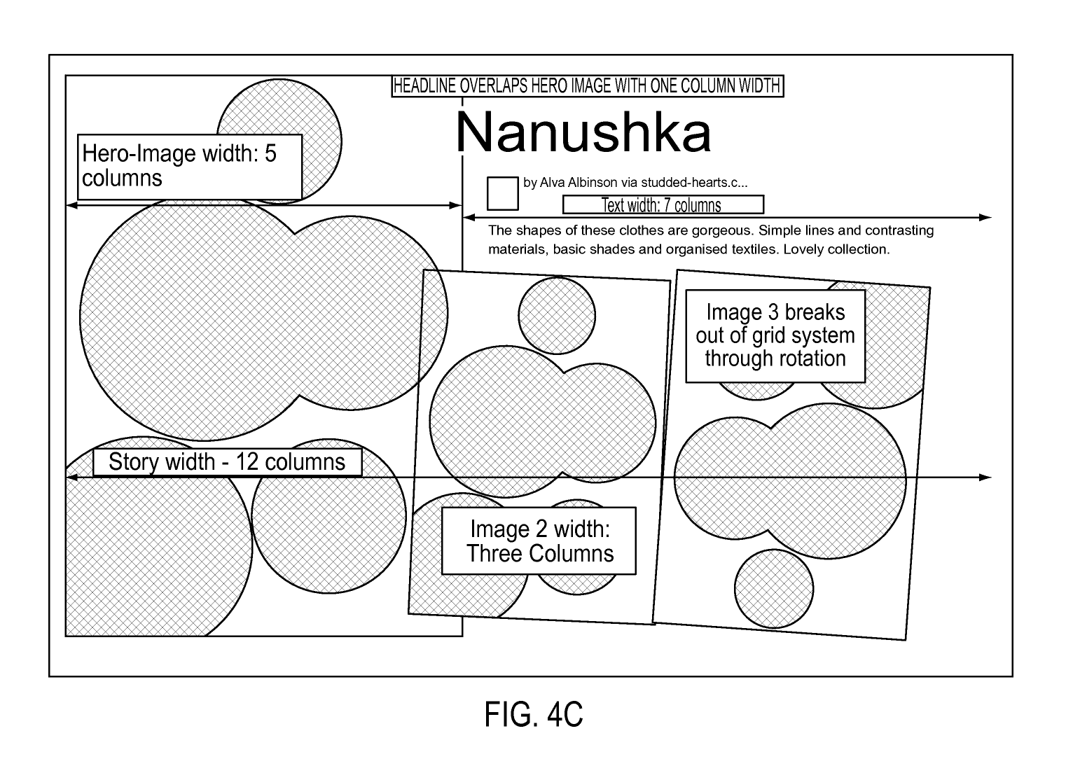

FIG. 4A illustrates another example of a story layout that includes a headline container 401, a long-text container 402, and three image containers 403, 404 and 405. The illustrated example does not illustrate actual borders of element containers since it is intended to represent the actual display of a story after its layout has been configured. The headline container 401 has a width of 6 columns, the text container 402 has a width of 5 columns The image containers 403 and 404 are fit in the space between the text container 402 and the largest image container 405. This space has a width of 2 columns The image container 405 has a width of 5 columns. The image container 403 has a vertical orientation whereas the image container 404 has a horizontal orientation. It should be appreciated that the sizes and other attributes of the element containers of a story layout can be customized by the layout engine depending on various factors, which will be explained in more detail below. FIGS. 4B and 4C illustrate further examples of a story layout with differently configured element containers.

A page layout may be configured based on a variety of factors. The factors include, but are not limited to, screen resolution, properties of the surrounding pages, properties of the stories contained in the feed, properties associated with devices that are displaying the content, and preferences of the readers which may be pre-selected by the readers or automatically determined by the layout engine based on a history of the user activities.

Screen resolution refers to the underlying design grid of a display device for displaying the content, e.g., a display device of a viewer-user. A layout engine configures the layout of content based on screen resolution such that the content is displayed in the most optimal way for each viewer. For example, a layout engine stores a table that lists types of screen resolutions on one side and options for page layout that can be used for corresponding screen resolutions on another side. An example table which illustrates exemplary combinations of story container widths for a range of screen resolutions is provided below.

TABLE 1
Correspondence Table of Screen Resolution and Page Layout

| Common Screen | Columns | Examples of story container |
|---|---|---|
| Resolutions (width) | (width) | configurations |
| 640 px | 8 (624 px) | (4, 4)-(8) . . . |
| 1024 px | 12 (936 px) | (4, 4, 4)-(4, 8)-(6, 6)-(12) . . . |
| 1280 px | 16 (1248 px) | (4, 4, 4, 4)-(4, 4, 8)-(4, 6, 6)- |
| | | (4, 12)-(6, 10)-(8, 8) . . . |
| 1600 px | 20 (1560 px) | (4, 4, 4, 4, 4)-(4, 4, 6, 6)- |
| | | (4, 6, 10) . . . |
| 1920 px | 24 (1872 px) | (4, 4, 4, 4, 4, 4)-(4, 4, 8, 8)- |
| | | (8, 8, 8)-(12, 12) . . . |

Referring to Table 1, the design grid may be selected in a way that it will allow the reuse of the containers in the most common resolutions. One column has a size of 48 px+30 px margin (78 px total) in the configuration table above, but may have different values depending on desired design specification. For example, for a display device having resolution 640 pixels, the layout engine may have a page layout that has two 4-column width story containers, or a page layout with only one 8-column width story container, or any other configuration not explicitly listed in the table.

Properties of the surrounding pages may refer to one or more attributes of the layout configuration of certain number of immediately previous or subsequent screen pages (e.g., 1, 2, 3, 4, 5, 6, 7, 8, 9, 10 screen pages immediately before or after the feed being configured). These criteria may be used to configure the continuity of the layout style of two or more screen pages. For example, the layout of continuous screen pages may be arranged to have smaller-size stories in the beginning and larger-size stories (e.g., main stories) in the end, or vice versa. Such configuration may be used to build a climax for readers resembling that of a print edition (e.g., teaser stories in the front sections of a magazine, main stories in the middle sections and other informative stories in the back sections). Alternatively or additionally, the layout of continuous screen pages may be arranged to not show the consecutive pages with the identical layout.

Properties of the stories may refer to information relating to, non-exclusively, image resolution, absolute story popularity, relative story popularity, image type (e.g., product vs. non-product), image color scheme, image contrast, image ratio (landscape vs. portrait), other similar features such as cropped/croppable product image, full sizable image (so can it be used as a lead story), etc. Further, a lead story determination may further be based on number of images and/or image resolution.

Popularity of a story may be measured using a number of metrics such as a number of hits received by a story, a click-rate of a story, a number of “likes” (e.g., a user's affirmative positive feedback) received by a story, etc. Absolute story popularity and relative story popularity may be measured using the same or different set of metrics. Absolute story popularity may refer to a measure of popularity for each story in the feed, measured using the same set of metrics. Relative story popularity may refer to a relative measure of popularity of stories having a common attribute (e.g., differences in the measures of popularity of stories appearing in the same container, same screen page, etc.). Based on one or more properties explained above, the layout engine may determine the page layout. After determining the page layout, it may determine the story layout.

Similar to the page layout determination process, the story layout determination process may include selecting a story template among a predetermined list of story templates. In some examples, the selected story template may further be adjusted according to certain characteristics of the feed.

The selection of the story template may be based on a variety of attributes of the story being configured, which include, but are not limited to, attributes of the story container where the story being configured will be displayed, structures of the story, semantic information of the story, and image attributes if an image is included in the story.

Attributes of the story container may refer to a size, a location, an orientation, etc. of the container. Structures of the story may refer to the headline, length of the headline, length of the text in the story, number of images in the story, image ratio, etc. Such structural information of the story does not depend on the content of the story whereas semantic information of the story does depend on the content of the story. Semantic information of the story may refer to the content of each of the images included in a story (e.g., whether it is an image of an isolated product such as jewelry, shoe, food, etc., a person/model, or the like.), and/or the pattern of images if more than one image is included in a story to configure the pattern of the story (e.g., if the first image does not feature a product, but the rest of the images feature a product, then the story configuration may likely be the “shop the look” in which the first image relates to a collection of products, and the following images feature each of the products in more detail). Further, the semantic information may include information relating to the image brightness, saturation, contrast and colors. In some examples, semantic information of the story may also refer to the topic or category of the story as well as the type of the text of the story (e.g. interview vs product description). Additionally, it may refer to the tone and statement of the story (objective description vs. opinion).

In some embodiments, the style of the layout (either at the page level or the story level) may be additionally determined and accounted for in either the determination process for the page layout or the story layout. There may be a number of high level style options made available for user to choose. These styles may include, but are not limited to, a news-magazine style layout with tidy arrangements of stories, a fashion-magazine style layout, a shopping brochure style layout, or the like. A user may select one of these styles. Then the layout engine selects an algorithm/rule associated with the style selected by the user to configure the detail of the layout according to the selected style. For example, the layout engine may determine the following details to produce the layout in the style selected by the user: a font family (e.g., crazy vs. serious font types), a font style (e.g., eye-catching vs. fine and more subtitle types), a font size (e.g., small vs. big and eye-catching sizes), capitalization of the letters (e.g. headlines in capitals vs. small letters), color (e.g., high saturation vs. low saturation), an image size (e.g., a few large-size images vs. crowded small-size images), image overlapping (e.g., whether two or more images should overlap with each other, if so, how much overlap is desired between which images, etc.), an image ratio (e.g., whether any image should be cropped, if so, by how much in what dimensions, etc.), or the like.

In certain embodiments, any one or more of these features can be manually customized by the user. In yet other embodiments, the layout style selection can be made automatically, based on the analyzed topics related to the stories in the feed, without needing any user's manual selection.

Examples of features that are customizable by users (e.g., creators of the content and/or readers of the content) and examples of user interfaces that are provided to the users to make such changes are provided herein:
a user interface that allows users to select from multiple tags or topics using a dropdown navigation menu.
a user interface that allows users to configure setting such that a layout of any particular content is automatically changed or modified according to some data or feed collectable in real-time.
a user interface that allows user to change text settings (e.g., font, size, color, etc.) using a dropdown menu.
modifiable features include, but are not limited to, number of different page templates (e.g. more product spreads for more monetization), general style of the layout (e.g., playful-serious in a scale from 1 to 10), target readers' age group (e.g., the layout configured based on this input), size of a margin between two adjacent stories, orientation of an image (e.g., rotation of tilted images vs. only horizontal/vertical orientation), text setting, whether to display multiple pages as distinct pages or as an endless stream of content, or the like.

In particular, the users are allowed to customize the general style of the content by selecting between an edition style or an endless stream of content style. In the edition style, one or more display pages that are pre-selected to constitute a single edition are configured as one single distinct edition organized to have, for example, a climax and an indexation, etc. This style may include a front of a magazine issue, main stories/content, and a back of the issue. The layout engine may determine for each of the stories to be included in the edition where a story should appear. Each story container may still be separately styled. Further, as would be apparent to one of ordinary skill in the art, the available features for the layout engine may be updated to include newest technologies in the market (e.g., text/image setting upgrades, etc.).

The automatic configuration of the page layout and the story layout may be performed by the layout engine, more specifically, an algorithm that is pre-stored in a memory of a server or a browser. The algorithm may be executed by one or more processors of the layout engine. The process generally includes two steps—the first step of analyzing a set of attributes associated with one or more stories in the feed, and the second step of configuring the page layout and the story layout based on the analyzed set of attributes. In the first step of analyzing a set of attributes associated with one or more stories in the feed, the layout engine may be configured to analyze only a predetermined set of attributes that are relevant to determining the page layout or the story layout. Such attributes may include, but are not limited to, the structural configuration of the stories in the feed, semantic of the stories in the feed, or the like.

In some embodiments, the page layout and the story layout may be determined by selecting a page template and a story template out of a predetermined set of page and story templates. The selection of the page and story templates may be done based on certain attributes of the stories in the feed. Six example ways of using the one or more attributes of the feed to determine the page and story templates are described herein.

First, if one story has a high popularity and large images, the algorithm may use the large “lead story” page templates.

Second, if one story is very popular and a few other stories are not very popular, e.g., the popularity levels of the stories vary by a certain large enough number, the algorithm may use the “small story” page templates for the more unpopular stories and display the most popular one in the biggest way.

Third, a bunch of stories will be loaded and analyzed sequentially (e.g., ordered by the publishing date, popularity, or the like). Stories of the same type may be put together in one page template. For instance, five stories may be loaded and if the first two stories are photo-stories then a 2-photostories-page-template will be used. If the following 3 stories are short stories, the next page template will be a 3-short-story-template, and so on.

Fourth, there may different categories of the page templates, examples of which categories can include, but are not limited to, photo series (e.g., headline and without text and 3 ore more photos), product spreads (e.g., headline, short text and up to 10 product images), short stories (e.g., stories with a headline, short text and 1 or 2 images), long stories (headline, long text, and up to 10 images), cover stories (e.g., stories with a lot of popularity, stories with a large number of product images), video stories (e.g., story with a headline, short text and one or more videos), or any combination thereof.

Fifth, depending on the selected page template, the order of the stories in the page can be changed.

Sixth, depending on the semantic information, an html structure may be selected, and the story data may be rendered into the selected html structure. The pre-analyzed story attributes may be added as css classes to the html structure. The six examples described herein may be used separately or in any combination thereof. Further, it should be appreciated that the above decision criteria/factors are provided herein only as examples, and that many other alternative/additional options/factors can be added to the process for selecting/configuring the page template without departing from the core concepts of the claims.

There can be many other alternative or additional ways to determine the page and story layouts—e.g., how many and/or which stories are going to be included in the feed for display. Another example way is to allow the layout engine to determine an appropriate page layout first, determine how many and which stories will be displayed to the user (e.g., viewer of the content), and then configure story layout for each of the selected stories for display. Further, if the number of stories inputted by the creator-user exceeds the number of stories that can be accommodated by the selected page layout, the layout engine, after selecting a portion of the inputted stories for display, holds the unselected stories in a memory for display on a different page (e.g., next page, or other).

In some embodiments, the stories that are inputted by the user may not all be displayed, and the layout engine determines which stories are going to be displayed, and how many of them are going to be displayed using which layout configuration.

This may be similar to a print magazine where the stories are not displayed by a simple order such as a chronological order, but instead they appear in a way that can have the most impact on the readers, for example, presented in the order of importance or popularity starting from the highest on the cover page. Or it starts with a cover page that includes a summary of most popular stories, followed by a table of contents, then shorter stories in the beginning to be followed by longer titled stories with large photos and interviews as large spreads over multiple pages, and then smaller announcements and a preview of the next issue at the end. This format may be mimicked for the layout engine for automatically configuring the page and story layouts of the feed. This format that mimics an actual print magazine may be preferred for table applications such as iOS for iPad, but this format may be used for other operating systems and devices.

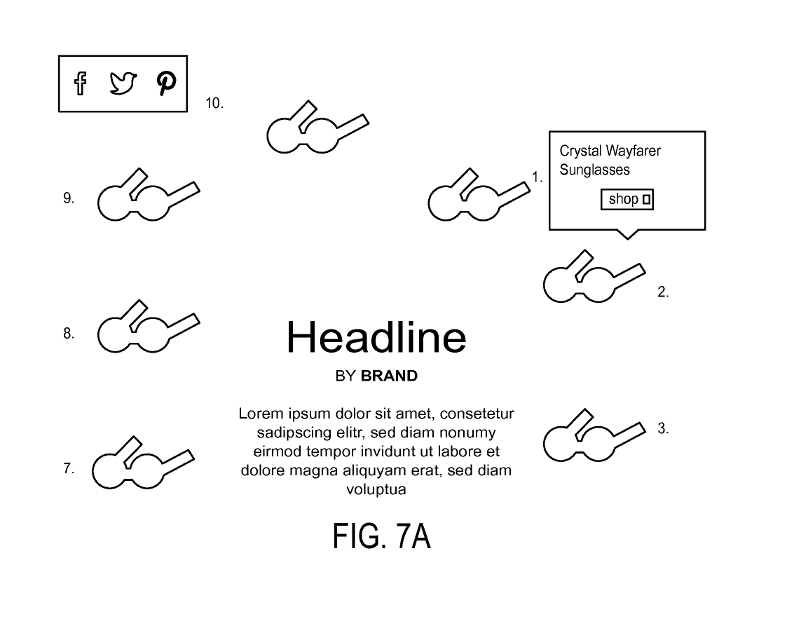

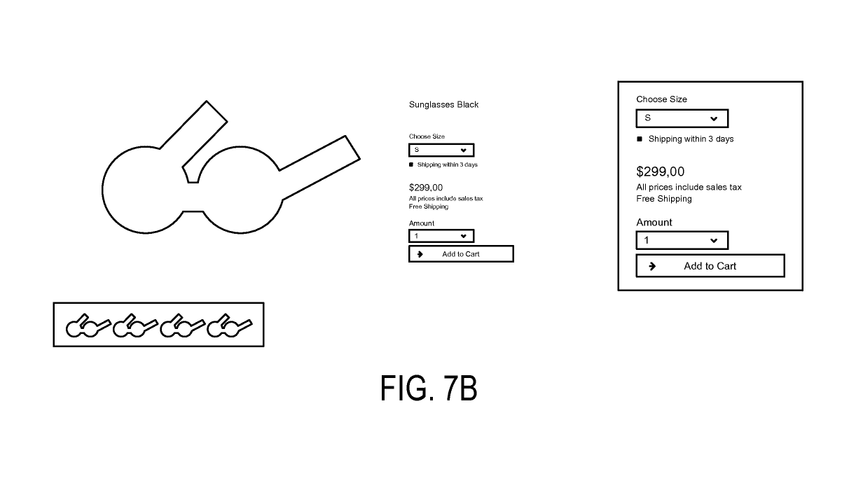

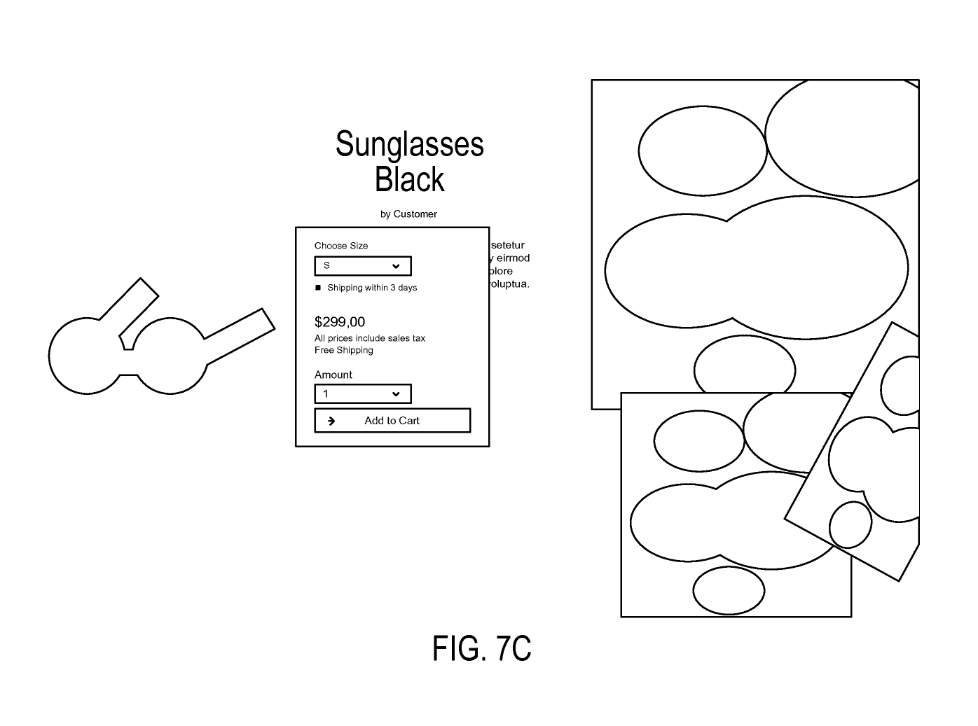

Next described are example ways of displaying the stories for online shopping or e-commerce. In some embodiments, the display engine may configure the layout one or more stories in a page as an actionable item (e.g., a shop-now or add-to-cart item, etc.). FIG. 7A illustrates an example of a page template where one or more stories are an actionable item. Shown in the illustrated are images of products, which can be purchased directly via the “add to shopping basket” feature integration. For example, as shown in the illustrated example, a reader of the content may move the mouse over the product 2, which will cause an action menu associated with the story (“shop it” button) to appear next to the selected story. The reader may proceed to order the product featured in the selected story 2 by clicking the “shop it” button. In this way, merchandisers (creators of content) can display their stocked products in a professional and visually pleasing manner In some instances, bloggers who are not merchandisers can act as creators of the shoppable content in which case the displayed content will not be the items stocked at the content creators but stocked at one or more third-party merchandisers.

FIG. 7B is another example of a “shop now” feature. The illustrated example in FIG. 7B contains additional data of the product and also provides the feature called “add to shopping basket.” This feature streamlines the shopping process for the user such that the user does not have to go to a different website, search through the website to find the desired item corresponding to the item shown in FIG. 7B, and then shop the item from the website. The display includes more detailed information about the product of the selected image and permits the user to further clarify which specific size and amount of the product should be placed into the user's shopping cart, as well as the option to add the chosen product directly to the shopping cart. FIG. 7C is still another example of a “add to shopping bascket” feature. The layout engine may customize the display that is triggered by the “shop now” feature for each image based on various attributes of the image selected by the user and display resolutions.

As shown in the illustrated examples in FIGS. 7B and 7C, the “shop now” and “add to shopping basket” features can be integrated with a shopping basket. The content-creator can upload images of a variety of products that it wants to promote or sell in the marketplace using the layout engine. The images are professionally displayed in a visually pleasing manner by the layout engine. Further, the images are displayed with a shop-now feature and a shopping-basket feature through which the users (viewers) can see the displayed images, select an image of the product that they want to order, and place the order without leaving the display page, i.e., shop seamlessly from the layouted magazine they consume.

In some embodiments, the content-creator provides a simple, small image frame that contains the “add to cart” button, separate from the story feed. By clicking this button, the user (e.g., viewer) can shop right out of the display page created by the layout engine. The content-creator can provide a reduced version of its existing checkout page (e.g., the page where the product is displayed), which contains the relevant information such as the “add to cart” button, the pricing information, the discount tag, selectors for sizes, colors, etc. Such a frame may be displayed on top of the story it is associated with, or can be displayed as a hovering screen over the associated story which appears when the mouse clicks the story or stays on the story for a certain amount of time.

The layout engine may use the images of products in the stories and make them directly shoppable from the display. Just like regular editorial images, pictures of products can be used as a component of a story. An image of a product may be treated as a regular image but can include certain information of the product such as the price, the store where the products are available for sale, quantities, colors and sizes they are available in, availability in stock, time for shipment, shipping cost, etc.

Much like in a lifestyle magazine, products can be displayed in a group of only products (see FIG. 7A) or in combination with a non-product image, e.g. a celebrity wearing an outfit and depicting one or more pieces of this outfit separately next to the person, sort of like a detailed view on the products. The idea is to link the products to emotions or dreams of the readers or to give them a better understanding how this product could be worn or show them how it would look in real life.

The layout engine may enable readers to shop directly from the magazine, which can be done either by a customer (e.g., a shop) that registers with the service provided by the layout engine and posts images of its products using the service of the layout engine, or by a customer that integrates products from any website from which we can get information on the product. In this way, shoppers (e.g., readers, viewers) can seamlessly add products to their shopping cart while browsing the magazine. These actions are transferred back to the ecommerce software of the shop so it knows items have been added to the shopping basket.

Depending on the level of information available for the customer and the products, the layout engine can add the following features: a) a “shop now” or b) an “add to shopping basket.” The “shop now” basically only states the name that the image of the product has been given and links back to the originating domain. In some embodiments a code can be added to the link which identifies the creator of the story or the originating website as the referrer of the user clicking the link, in order to credit the former with an affiliate provision in case the item is purchased by the user via this link. This is a very light integration where the layout engine has not received a lot of data about the product from the shop/customer. In this case, the product is usually, but not necessarily, identified only by the domain of the originating image, which is usually that of the shop.

Option b)—the “add to shopping basket” function—is a deeper integration where the layout engine has received additional data about the product from a public or private database. This is an integration with an existing ecommerce software used by a company or user input. Having additional information about the product allows the layout engine to determine relevancy for the reader. Simple things could be gender—e.g., a man would not see a purse—and more refined factors could be preferred colors of the shopper, previous buying behavior regarding price range and brand. All these factors can be used to determine relevancy. The layout engine could also link our information with that of advertising networks—e.g., display yellow shoes if a user has searched for this term on other pages.

The information displayed in the overlay does not need to be an overlay, but instead could be displayed anywhere neighboring the image. The information can be loaded from a modified version of the client's “add to cart” function, which usually is in a different form than what is needed for the layout engine, with the surrounding information on the product such as price, colors, sizes, etc. Such information may also be received by the layout engine by an API or some other kind of a file that is suitable to be rendered by the layout engine.

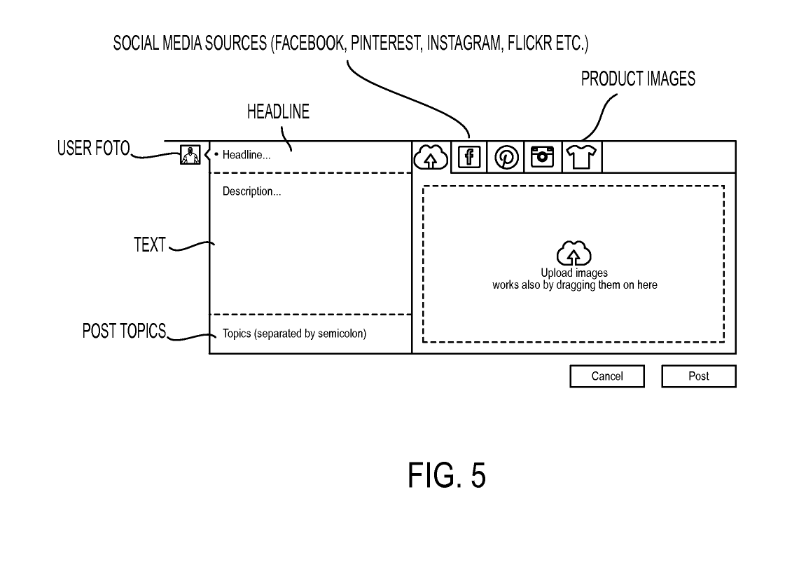

Products may be selected by any person including, but not limited to, a staff of a shop using the magazine service of the layout engine, an ambassador of a store or a brand or an entire user-base for the reverse publishing solution explained below. Also, products that are retrieved as described below can be shown in one of the tabs of the editor-tool shown in FIG. 5, the t-shirt shaped button, in order to make them available for the creator of a story. This allows brands to publish new articles very efficiently or have their readers create stories from preselected groups of products, e.g. either from one brand, from one collection or also around one specific topic or theme.

The layout engine may use a customer (a shop)'s API or a database-file (.xml or similar) provided by the shop to obtain product data such as prices, availability of the products (either real time or cached), etc. Thus, the layout engine may be able to connect to the Shop's API or stream in the file and load the relevant data for the specific product. Through this, a selection of products can be provided when users create stories, as explained above. These products may be searchable by the users and can seamlessly be used in stories just like any other image, but containing the additional information mentioned above.

A plugin may be provided such that it is installed in an ecommerce platform (e.g., Magento, Oxid, Shopware, Shopify and others), which can provide appropriate APIs or database-file to allow the “add to shopping cart” functionalities. These APIs or database-files include but are not limited to basic product information (such as product name, description, products images, link to the product page, product id and other), information needed to display the add to shopping cart overlay or tooltip (such as current and old price, currency, availability, configurable options if they exist, and tax information), an API to add a product to the shopping cart based on product id and selected product option, and a refresh cart API that updates the shopping cart view.

Such plugin may also provide additional functionalities to integrate the layout engine on external websites, such as, for example, providing a magazine path that contains a user's profile view containing the feed of the user, a view to display specific stories based on a tag, category, or other parameters, and the story view containing a single story. The plugin may in some embodiments additionally grab crawlable content like header information (such as meta tags) and generated HTML from the layout engine server and parse it into the view's HTML to ensure that stories are indexed on the client's domain.

Optionally, the “add to shopping cart” overlay or tooltip may also be provided as a template by the ecommerce platform and integrated by the layout engine through an iFrame.

In order to optimize the story layout, the display of product information, the display of a “shop now” button and a “add to shopping basket” button, and isolating or cropping the image automatically (all mentioned above) within the magazine, the layout engine can identify which image is an image of a product for sale. Below described are four example ways to do determine whether an image contains a product:

1. User Input: when a user writes a story, they can select whether there is a product depicted in the image. Through a Search-functionality on APIs as well as products in our own database, the layout engine may be configured to ask the user to identify which product exactly is depicted on the image, possibly making suggestions based on the images properties such as originating domain, color, shapes, etc.

2. API-Integration: when a shop's API is integrated, the layout engine may receive information about which images are featuring which products and store further information about the featured products in a database configured to communicate with the layout engine.

3. By Domain: a list of the domains of online stores may be saved on the layout engine or a server configured to communicate with the layout engine. In case an image originates from a domain in the list, it is regarded as a product and displayed as shoppable in the feed. For example, any image from adidas.com is regarded as a product. The domain list can be manually created and edited, and /or can be streamed in from one of the shop aggregators (e.g. shopsense) available in the market.

4. Image Recognition: third party image recognition services or a proprietary image recognition algorithm may be used to detect the products featured in the images and identify which products are depicted.

Based on the analyses above, images which contain products can be identified. This information may be used, so that the layout engine may apply certain rules of automated cropping, cutting out and isolating the product from the background of an image, if the layout engine determines that the image in the story feed contains an image of a product.

Next described are examples ways of displaying stories for a cover page of the magazine. In some embodiments, the layout engine may determine which stories are going to be displayed on the cover page, or which element of the selected stories are going to be displayed in which format, based on the popularity of the stories and other attributes of the elements contained in the stories (e.g., image size, resolution, length of the text, etc.) For example, the layout engine may determine whether a story has a popularity greater than or equal to a threshold popularity for a cover page, and whether an image of a story has a size greater than or equal to a threshold image size to be on a cover page. The cover page may be configured such that the headlines of other stories that are not selected for the cover page overlap, or hover over, the image selected for the cover page, for example, to serve as a teaser.

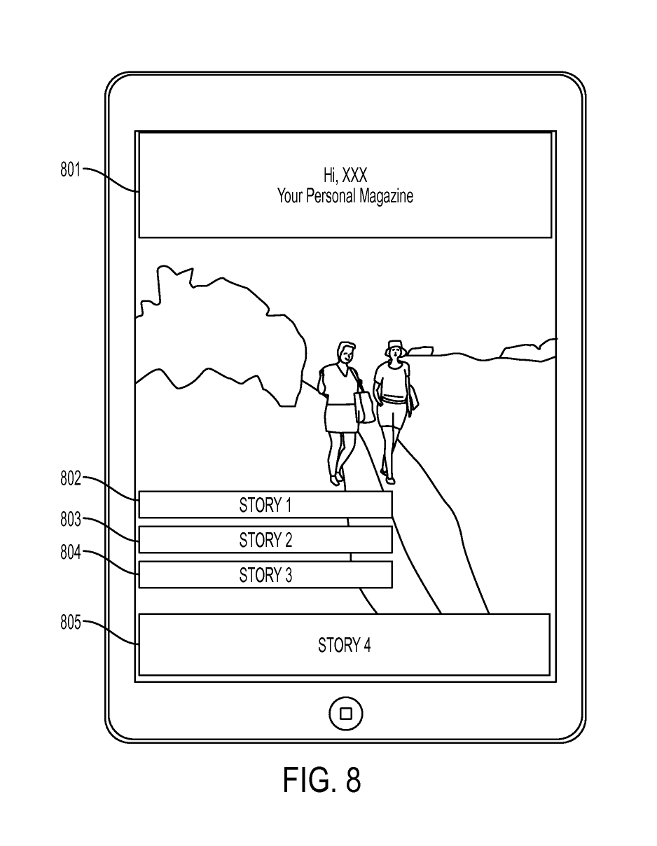

FIG. 8 illustrates an example of a cover page of an issue for display. The display is customized for a particular user/viewer if the user has pre-registered user profile, as shown in 801. The user profile may include user preference of story subjects, name, age, etc. Stories 1, 2 and 3 could be displayed on the cover page only with their titles in narrow story containers 802-804, respectively, and no other elements (e.g., images, texts, etc.) are displayed. Story 4, which may be a story with more impact or importance than the first three stories, can be displayed more prominently: One of its images can be used as the issue's cover image and container 805 may accommodate two or more elements of the story 4 (e.g., title and a first line of the text).

As shown in the illustrated example, the username associated with a logged-in user may be used to personalize the issue of magazine: for example, the cover page of the magazine may include a automatically adjustable statement “Your Weekly Issue, XXX!”. The issue may be personalized based on a variety of characteristics such as other users (e.g., authors) followed by the user, topics associated with the user (e.g., the topics that the user has shown interest previously), similarities in the taste of certain types of products compared to other users, or the like. These attributes may be monitored by and stored in the layout engine that includes, or is connected to, a storage device.

Further, a different set of templates and/or algorithms may be applied for determining the page layout and the story layout of a story, based on different attributes associated with a story. For example, there may be a set of templates and/or an algorithm for stories having a video file. There may be another set of templates and/or an algorithm for stories having lengthy texts (e.g., an interview) that include certain threshold number of words, and one large image. There may be another set of templates and/or an algorithm for stories having two or more large images each with a separate caption (e.g., photo shoots). There may be another set of templates and/or an algorithm for stories with short texts (e.g., that have less than a certain number of words). There may be another set of templates and/or an algorithm for stories that are used as a teaser, examples of which teaser stories may include a certain number of images (e.g., 2, 3, 4, 5, 6, 7, 8) taken from other stories that are expected to appear in the next issue of a magazine

The above described techniques are provided herein only as examples. It should be appreciated that there can be a variety of ways to modify or add to the above described techniques which include, but are not limited to, changing the order of templates, parameters for determining/selecting different types of stories or templates, or the like. The parameters and rules may be predetermined in the layout engine or adjustable by users. Alternatively or additionally, these features may be automatically adjusted by the layout engine based on one or more characteristics of the users such as, the number of visits the user makes in a predetermined time period, the number of issues the user creates in a predetermined time period, the types of issues the user prefers (e.g., videos of action sports vs. images of fashion), or the like.

Before the layout engine can configure the layout of one or more stories in the feed for display, the layout engine must receive, or be inputted with, one or more stories for analysis. How a story can be created is explained below.

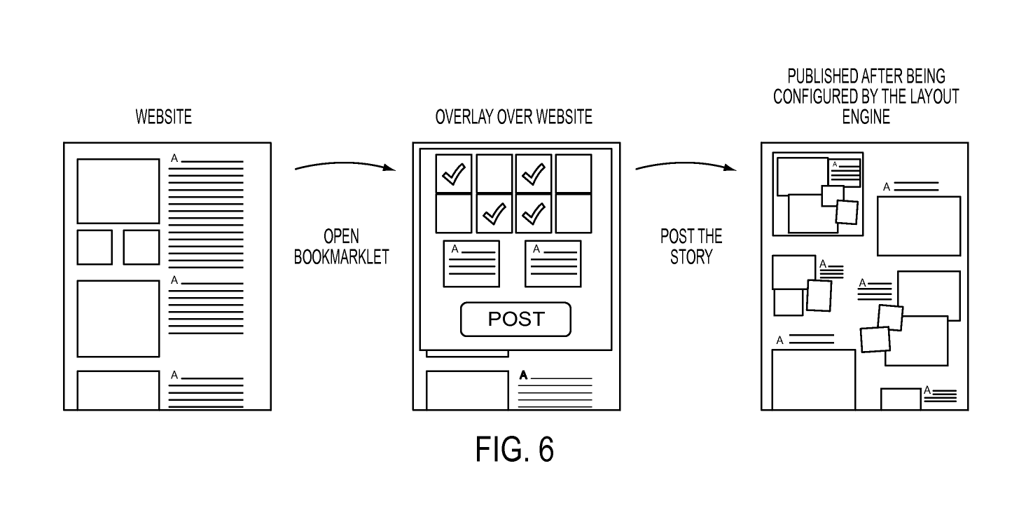

FIGS. 5-6 illustrate example ways to create a story. As explained above, the content of the feed may include one or more individual elements called a story. In some examples, a story may include only one element (e.g., text or image) or at least one image or video and a headline. Text can be entered in the story, individual captions for all images (containing information about the photo, prices, etc, much like in a print magazine), as well as topics/keywords of the story which enables filtering by individual topics and identifying similar stories. In this setup of determining/selecting content for a story, the user does not need to worry about the layout of such content—e.g. how the images, texts, headings, etc. are arranged—except for defining the order of the images. The layout of the content may be configured automatically using the page layout and the story layout as explained above. In other embodiments, there can also be an “advanced mode” in which the user can create certain rules for displaying the story (e.g., never show less than 2 images), choose certain predetermined layout templates or layout features, exclude certain layout options, choose certain fonts and/or colors, reassign the locations of certain images and texts different from the predetermined locations in the template, or the like to allow more freedom for user to customize the layout of the content if preferred.

Additionally or alternatively, the user may have a selector or button on every page template that allows to switch from one page template to another one so that the display of all stories in the selected page template can be changed for review. The same method may also be applied for single stories so that users may flip through altering depictions of the same content and save the display they find best. During use of these features, story templates may be excluded from further automatic manipulation by the layout engine in order to keep the chosen look & feel.

In some embodiments, there may be two ways to create a story. First way would allow a user to create a story using an editor-tool (e.g., a user uploading an image to the publishing system, using images stored in accounts with other companies online, or choosing images from a preselected set of images or searching for specific images to be used, etc.). Second way would allow a user to create a story using a tool called, bookmarklet, which can automatically pull one or more images and other content, including, but not limited to, text and keywords, from other online sites to the publishing system. Each of these ways is explained in more detail below.

FIG. 5 illustrates an example of an editor-tool. A user can log into the webpage of the publishing system and access the editor tool as shown in the illustrated example. A user can click on the “create story” area to start the story creation process.

The editor-tool allows the user to enter a headline, the text of the Story, upload images, videos, search for images/videos on a specific internet domain (e.g., website), search for images/videos on the web, choose any of the foregoing from connected sources such as Facebook™, Pinterest™, Instagram™, FlickR™, use images of suggested products that are pre-stored in the system or obtained via third party services (e.g. via an API), or enter topics for the story.

FIG. 6 illustrates an example of a process of using a tool called a “bookmarklet” tool. A bookmarklet tool allows a user to create a story from the open website (not associated with the layout engine). Open website may be any website accessible on the world wide web. In the illustrated example, a user may find a webpage that contains an item (e.g., which may be an image, a text, or both) that the user wants to publish while surfing the web. Then, instead of having to click the image and store a copy in a local hard drive to upload it back on the layout engine for publishing, the user can simply use the bookmarklet tool to overlie the webpage containing the desired item. Then, the bookmarklet tool automatically pulls (“clips”) relevant stories from the webpage. In other words, the tool pulls all the images and texts that satisfy certain conditions (e.g., having right specifications to be used by the layout engine, etc.) from the webpage and presents to the user, as shown in FIG. 6. Then, the user selects the desired item(s) that will form a story. Further, the bookmarket tool may take additional information from the user directly such that the information inputted by the user and the items clipped from the webpage together form a story. Subsequently, the layout engine automatically configures the page and the story layouts of the desired item for display. The desired item may be posted in a professional magazine-looking style, as shown in FIG. 6.

The bookmarklet tool may be implemented using JavaScript code. Functionally, some JavaScript code may be used as a bookmarklet at the user's browser. It may refer to a small amount of code the users puts in to the bookmarks bar of their browsers. In order to “clip” a story from the web, the bookmarklet JavaScript code loads a JavaScript file from the layout engine and injects it to the webpage the user is browsing at the moment. Then, the JavaScript code will read the page title, description and keywords and identify images used on the page. The data is then used to create a story and pushed back to the layout engine. The Java Script code basically works like a layer that loads on top of the visited website and extracts information like texts and images the user can subsequently choose to create their story. Another implementation can be, that the owner of a website implements the java script code into their website, so that users can share their content in the form of a story on another platform (e.g. a button users can click that triggers an action similar to the above mentioned java script code).

Some exemplary information that the bookmarklet tool may be configured to extract from a webpage includes, but is not limited to: the title meta tag of the page, the description meta tag of the page, the keywords meta tag of the page, all images starting at a certain minimum resolution, the title tag of each image, the alt-tag of each image, the text selected on the page before the user enables the bookmarklet tool, the analysis of the full html to identify the main text body, or the like. Further, bigger images that are presented on the exact website-location as mere “thumbnails” may be automatically searched, e.g. by following the links or checking the website's folder structure, in order to allow the user to use the larger image version that is stored in a different website-location.

Whether data is directly uploaded by the user or automatically clipped from an open website, the data may be stored in a server (e.g., a database) that is included, or is operatively connected to, the layout engine. For example, all the pieces of texts and the images that are used for published stories may be stored in the database. The images may be stored in their original sizes, and can be resized for subsequent usage to predefined sizes or resized on demand. Before the images are saved, the images may be analyzed for certain patterns to, for example, automatically crop monochrome backgrounds, picture frames (e.g., isolate the relevant aspect of the image), or the like. For example, if an image includes an image of a product shot with white background, the white background may be cut out so that the image of the product can be displayed with a closer view, or overlaid on top of other images. Further, patterns as those of erotic content may be automatically analyzed in order to not allow usage of such material.

After the stories are configured for display using the layout engine, the stories can be published on a platform associated with the layout engine. In some embodiments, these stories, which are displayed in a professional magazine-style using the layout engine, can then be out-transferred to, or integrated with, other websites not associated with the layout engine (e.g., a customer's page). One example way of integration with a customer page may be a non-search engine friendly feed integration.

A JavaScript snippet may be integrated into the customer's page. The snippet is configured to load the feed data (e.g., the stories of the magazine to be integrated with the customer's page) from the layout engine/server and render the feed into the html of the customer's page. This approach may prevent a search engine from indexing the content of the stories that is loaded on to the customer's page from the layout engine/server.

Another example way of integration may be a search engine friendly feed integration. To enable indexation with search engines, an HTML can be configured to be returned to the browser directly instead of being rendered with a JavaScript. To enable indexation with search engines, the customer's server can be configured to return a basic HTML representation, similar to that rendered normally by JavaScript directly in the browser of the user. That basic HTML representation of the website/feed/story can be generated by the layout engine. For example, a “template” page (where a JavaScript snippet can be integrated in to) similar to the one created in the non-search engine friendly approach explained above may be created on the customer's system.

This template page is configured to allow navigation of the customer's website and access to all other elements on the customer's website, as well as access to the JavaScript snippet prepared by the layout engine/server.

Optionally, the customer may create a CNAME entry for a sub domain, e.g., magazine.customer.com, which contains the domain name associated with the layout engine. Still optionally, the server of the customer may create a redirect (e.g., on Apache with mod_proxy) for all redirects to a certain path on their system. This redirect can be configured to point to the layout server associated with the layout engine, which layout server handles the HTML generation.

Further, the layout server that handles the HTML generation may request to receive the template previously created on the customer's system. After receipt of the requested template, the layout server may insert in the template the SEO crawlable content of the requested page. Alternatively, the layout server may render the HTML of the template with a headless browser (e.g., phantomJS) and return the generated HTML to the user who requested the display page. Additionally, a CDN may be used between the layout server and the customer server to cache the results. Further, if the request contains cookies, the HTML generating engine (the layout engine) will forward such cookies to the customers Template Page to get the personalized representation of the customer's template (e.g., containing the value of the shopping cart or the name of the user). If the request has no cookie the customer's template may be cached.

Any adaptations can be made to accommodate the customer's preferences on various features of the publication and stories, which preferences can include, but are not limited to, fonts of text, colors of text, colors of backgrounds, or the like.

Further, in some embodiments, a solution may be provided to customers so that they can use the automatic layout engine to configure the stories for magazine style publication and publish the configured stories on their domains. This solution may include a “reverse publishing option” to allow users of the customers' websites to sign up and create an account to use the layout engine to get full access to the functions provided by the layout engine (e.g., clipping stories from the open web, automatic configuration of the page and the story layout, etc.). Further, the reverse publishing solution may allow the customers to create a social network on which other users can sign up and contribute stories, optionally using the layout engine remote from the customers and users, on the customer's network.

The foregoing solutions for integrating the layout system with other customers' websites, may permit such customers to customize the publishing of the stories with a greater freedom beyond the fonts and colors (e.g., how the published stories will be integrated with their navigation tools, modifying core components of the customer system, developing new features for customers, etc.) while still getting the benefit of automatic configuration of the layout of the stories.

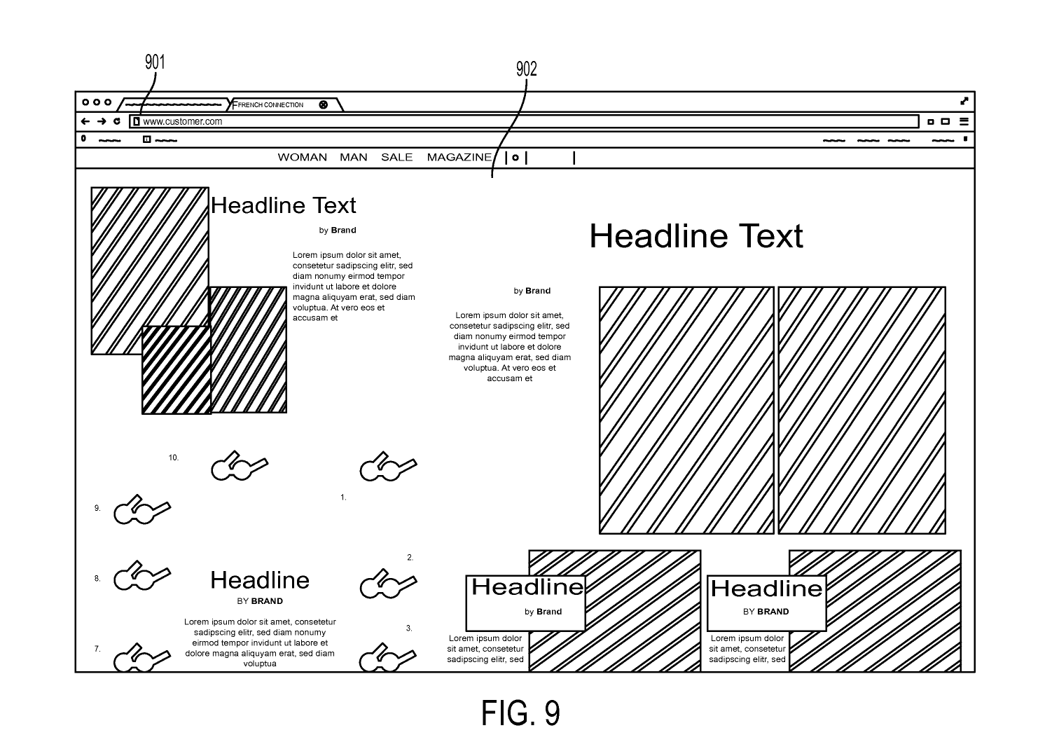

FIG. 9 illustrates an example of an issue integrated with a customer website. As shown in the illustrated example, the stories configured using the layout engine may be integrated with online shopping sites. An online shopping site (a customer) may want to display their products in a fashionable way, which can be done using the layout engine, without having to hire computer programmers or designers to redesign the layout of their sites, stories, etc. The layout engine may use a shop's API or a database-file (e.g., .xml or other) provided by the shop to obtain product data such as prices, availability of the products, etc. The layout engine may connect to the shop's API or stream in the file and load the relevant data for a specified product. A selection of products may be provided when the users create the stories. These products may be made searchable and may be used in the published stories without losing the feel of a magazine style layout. In the illustrated example, the display layout configured by the layout engine 902 is integrated and thereby displayed on the customer's URL 901.

Further, in some embodiments, in order to maximize the effect of advertising from publishing images of products for sale, the layout engine may be configured to identify which images of the published stories contain an image of a product for sale. In some embodiments, a user may identify its story as containing an image of a product for sale when the user creates a story. Further, when the user identifies it so, the layout engine may be configured to search, using the search functionalities on APIs, the database stored in the layout server, and recognize which product is featured in the image. The layout engine may request the user to confirm the product. In other embodiments, the layout engine may recognize an image as containing an image of a product for sale by API-integration. When a shop's API is integrated, the layout engine gets information, from the shop's server and the database stored in the layout server, which images contain which products, and which of those product images are used in the published stories, etc.

In still other embodiments, a list of domains for online shopping sites may be saved in the layout server. In such cases, an image that originates from one of the tracked list of domains, is automatically registered as containing an image of a product for sale when used in the feed. For example, any image from macys.com may be registered as containing an image of a product for sale. This list of domains may be manually edited and updated, or may be automatically streamed in from shop aggregators (e.g., which put together all relevant shopping sites for certain types of products, etc.). In still other embodiments, the layout engine may recognize an image as containing an image of a product for sale by third party services. The third party image recognition services may be used to detect products featured in images and identify which products are being depicted using an image analysis. The image analysis may include automated cropping and isolating, comparing the most relevant portion of the image to a list of standard product images, etc.

In other embodiments, the layout engine may iterate a call on a client's API in order to retrieve information about the availability of a product inside a story. If a product in the story is not available anymore the layout engine may be configured in a way to either hide the respective product or to add additional information on the product (e.g. “not available anymore” or “only 5 items left”). If all the products in a story cross certain before adjusted thresholds as e.g. availability, the layout engine may be configured in a way so that the entire story will be hidden from display in the feed.

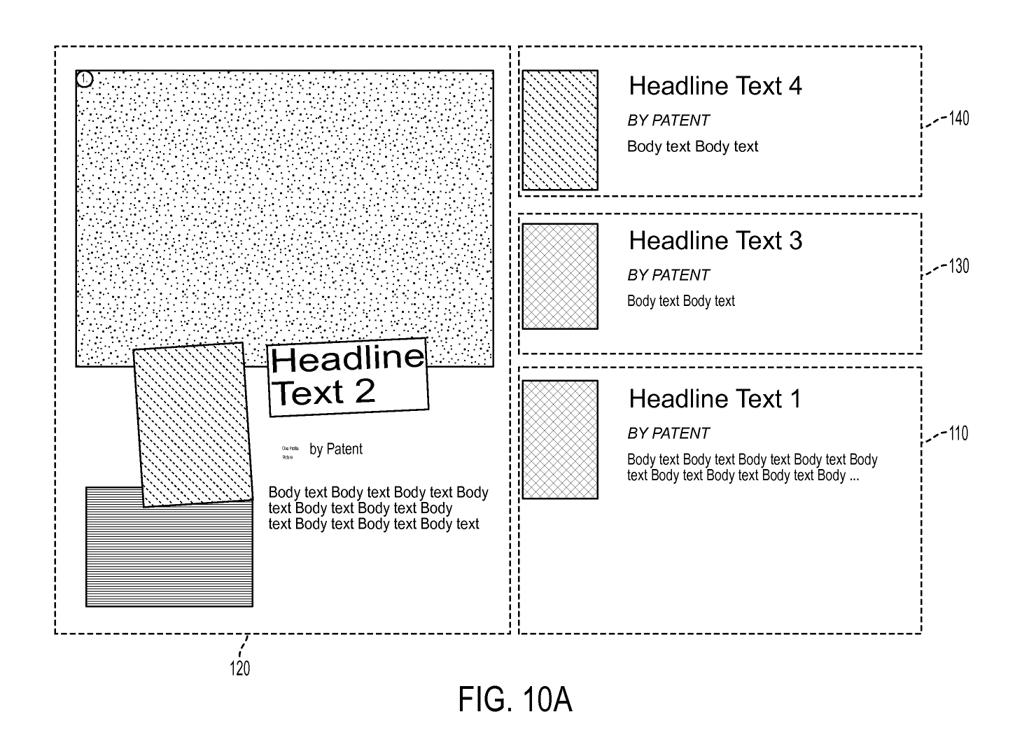

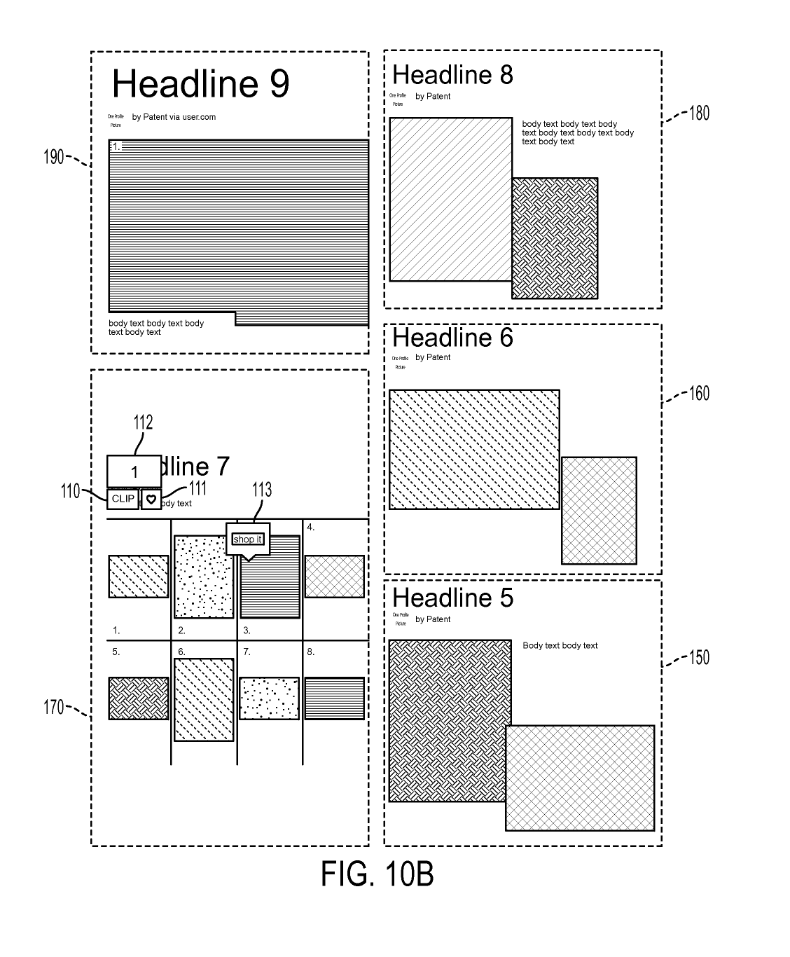

FIGS. 10A-10B illustrate further examples of a page layout according to various embodiments of the invention. The illustrated example of a page layout shown in FIG. 10A includes four story containers 110, 120, 130, and 140. The story containers 110, 130 and 140 have similarly layouts—having an image container on the left side and having a headline and a text container on the right side. The story container 120 has a differently configured layout having three image containers along with a headline and a text container toward the bottom right side of the story container.

The illustrated example of a page layout shown in FIG. 10B includes five story containers 150, 160, 170, 180, and 190. In the story container 170, the displayed images are shoppable items. For example, the “shop it” box 113 associated with image container 3 allows the user to shop the item displayed in the image contained in image container 3. Further, element 110 allows the user to clip the story contained in story container 170 and republish it elsewhere (including the user's magazine). Element 111 allows the user to follow the story contained in story container 170. Element 112 may be configured to represent the number of people who have so far clipped the story, or the number of people who have so far liked the story, or a sum number of both. The number shown in element 112 may be used to determine popularity of the story associated with it. Elements 110, 111, and 112 may be configured to appear for every story when a cursor is moved over to a particular story displayed on the screen—when a cursor is moved over to the story contained in story container 180, elements 110, 111, and 112 associated with the story in the container 180 appear, etc. Further, the pages shown in FIGS. 10A and 10B may represent two consecutive pages displayed on a screen as the reader scrolls down the display screen—e.g., the page shown in FIG. 10A followed by the page shown in FIG. 10B.

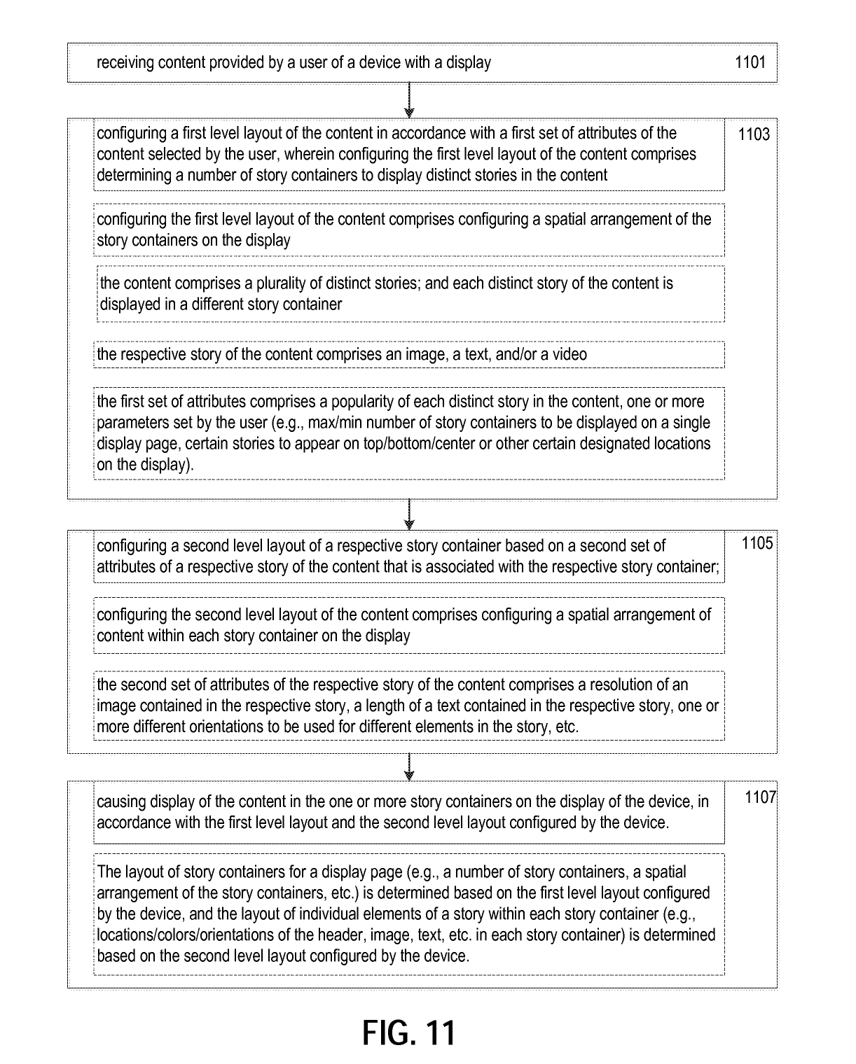

FIG. 11 illustrates an example of a processing flow for automatically configuring a layout of content provided by a user. At box 1101, the layout engine receives content selected by a user. The user selects the content through a website hosted by the layout engine, or through a customer website which then routes the selected content to the layout engine. Also, the user may select contents directly from various sites from the Internet without having to locally saving and uploading to the server. For example, the user selects a website that contains several images and text boxes directed to different stories, the layout engine determines which of those images and text boxes are the interest to the user based on the location of the selection made by the user on the website. Then, the user is prompted to confirm the selections, and if incorrect, the user can modify the selected images and text boxes. Once the selections are confirmed, the selected images and text boxes are automatically provided to the layout engine without the user having to locally store them and upload to the layout engine server.

At box 1103, the layout engine configures a first level layout of the content (e.g., a page layout) in accordance with a first set of attributes of the content selected by the user, wherein configuring the first level layout of the content comprises determining a number of story containers to display distinct stories in the content. Configuring the first level layout of the content comprises configuring a spatial arrangement of the story containers on the display. The content comprises a plurality of distinct stories; and each distinct story of the content is displayed in a different story container. The respective story of the content comprises an image, a text, and/or a video. The first set of attributes comprises a popularity of each distinct story in the content, one or more parameters set by the user (e.g., max/min number of story containers to be displayed on a single display page, certain stories to appear on top/bottom/center or other certain designated locations on the display).

At box 1105, the layout engine configures a second level layout of a respective story container (e.g., a story layout) based on a second set of attributes of a respective story of the content that is associated with the respective story container. Configuring the second level layout of the content comprises configuring a spatial arrangement of content within each story container on the display. The second set of attributes of the respective story of the content comprises a resolution of an image contained in the respective story, a length of a text contained in the respective story, one or more different orientations to be used for different elements in the story, etc.

At box 1107, the layout engine then causes display of the content in the one or more story containers on a display of the device (e.g., a display of the device operated by the user), in accordance with the first level layout and the second level layout configured by the device. The layout of story containers for a display page (e.g., a number of story containers, a spatial arrangement of the story containers, etc.) is determined based on the first level layout configured by the device, and the layout of individual elements of a story within each story container (e.g., locations, colors, orientations of the header, image, text, etc. in each story container) is determined based on the second level layout configured by the device.

Although the disclosure and embodiments have been fully described with reference to the accompanying drawings, it is to be noted that various changes and modifications will become apparent to those skilled in the art. Such changes and modifications are to be understood as being included within the scope of the disclosure and embodiments as defined by the appended claims.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate systems may be performed by the same system, and functionality illustrated to be performed by the same system may be performed by separate systems. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in multiple units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A method, comprising:
receiving content selected by a user of a device with a display;
configuring a first level layout of the content in accordance with a first set of attributes of the content selected by the user, wherein configuring the first level layout of the content comprises determining a number of story containers to display distinct stories in the content;
configuring a second level layout of a respective story container based on a second set of attributes of a respective story of the content that is associated with the respective story container; and
causing display of the content in the one or more story containers on the display of the device, in accordance with the first level layout and the second level layout configured by the device.

2. The method of claim 1, wherein:
configuring the first level layout of the content comprises configuring a spatial arrangement of the story containers on the display; and
configuring the second level layout of the content comprises configuring a spatial arrangement of content within each story container on the display.

3. The method of claim 1, wherein:
the content comprises a plurality of distinct stories; and
each distinct story of the content is displayed in a different story container.

4. The method of claim 1, wherein the respective story of the content comprises an image and a text.

5. The method of claim 1, wherein the respective story of the content comprises a video.

6. The method of claim 1, wherein the first set of attributes comprises a popularity of each distinct story in the content.

7. The method of claim 1, wherein the first set of attributes comprises a parameter set by the user.

8. The method of claim 1, wherein the second set of attributes of the respective story of the content comprises a resolution of an image contained in the respective story.

9. The method of claim 1, wherein the second set of attributes of the respective story of the content comprises a length of a text contained in the respective story.

10. An electronic device that automatically configures a layout of content, the device comprising:
a display;
one or more processors operatively connected to a non-transitory memory, wherein the memory stores instructions, which when executed by the one or more processors, cause the device to:
receive content selected by a user;
configure a first level layout of the content in accordance with a first set of attributes of the content selected by the user, wherein configuring the first level layout of the content comprises determining a number of story containers to display distinct stories in the content;
configure a second level layout of a respective story container based on a second set of attributes of a respective story of the content that is associated with the respective story container; and
cause display of the content in the one or more story containers on the display of the device, in accordance with the first level layout and the second level layout configured by the device.

11. The device of claim 10, wherein:
configuring the first level layout of the content comprises configuring a spatial arrangement of the story containers on the display; and
configuring the second level layout of the content comprises configuring a spatial arrangement of content within each story container on the display.

12. The device of claim 10, wherein:
the content comprises a plurality of distinct stories; and
each distinct story of the content is displayed in a different story container.

13. The device of claim 10, wherein the respective story of the content comprises an image and a text.

14. The device of claim 10, wherein the respective story of the content comprises a video.

15. The device of claim 10, wherein the first set of attributes comprises a popularity of each distinct story in the content.

16. The device of claim 10, wherein the second set of attributes of the respective story of the content comprises a resolution of an image contained in the respective story.

17. The device of claim 10, wherein the second set of attributes of the respective story of the content comprises a length of a text contained in the respective story.

18. A non-transitory computer readable medium comprising instructions, which when executed by one or more processors of an electronic device, cause the device to:
receive content selected by a user;
configure a first level layout of the content in accordance with a first set of attributes of the content selected by the user, wherein configuring the first level layout of the content comprises determining a number of story containers to display distinct stories in the content;
configure a second level layout of a respective story container based on a second set of attributes of a respective story of the content that is associated with the respective story container; and
cause display of the content in the one or more story containers on a display of the electronic device, in accordance with the first level layout and the second level layout configured by the device.

19. The non-transitory computer readable medium of claim 18, wherein:
configuring the first level layout of the content comprises configuring a spatial arrangement of the story containers on the display; and
configuring the second level layout of the content comprises configuring a spatial arrangement of content within each story container on the display.

20. The non-transitory computer readable medium of claim 18, wherein:
the content comprises a plurality of distinct stories; and
each distinct story of the content is displayed in a different story container.
